(19) United States
(12) Patent Application Publication
(10) Pub. No.: US 2013/0212947 A1
(43) Pub. Date: Aug. 22, 2013

(54) Load Bearing Structural Closure System

(71) Applicant: 420820 Ontario Limited, (US)

(72) Inventor: Shaul Goldenberg, Woodbrdige (CA)

(73) Assignee: 420820 Ontario Limited, Woodbridge (CA)

(21) Appl. No.: 13/761,934

(22) Filed: Feb. 7, 2013

Related U.S. Application Data
(60) Provisional application No. 61/596,323, filed on Feb. 8, 2012.

(51) Int. Cl. E06B 3/50; E06B 9/00

(52) U.S. Cl. CPC E06B 3/5054; E06B 9/00
USPC 49/168

(57) ABSTRACT

A closure assembly comprising at least two closures moveable in a closure frame, said closure frame including a header, sill and including a track sized to extend the full-length the header and sill thereby providing for guided movement of each individual closure to the maximum extent to and from a fully closed position, the at least two closures presenting a straight line, in-line, closure, such as a window, entry door, French door, patio door assembly and when the closures are pivoted from a closed position whereat said closures are parallel to the extension of said closure frame to a second position wherein free end of the closer is pivoted away from the closure frame, the free end of said closure including an inter-engaging member which inter-engage with adjacent members to brace together said closures thereby against any loading such as wind loads or the like.

### FIELD OF THE INVENTION

This invention relates to closure assemblies and particularly to those which may be used for windows doors, patio doors, French doors, and entry doors or the like and finds particular application in patio doors casement windows and specifically in a multi-closure frame including individually pivoting casement style windows particular which engage when fully closed namely all are closed and provides a continuous straight line appearance and when in the fully pivoted position provides maximum opening for entry and exit from the dwelling.

### BACKGROUND OF THE INVENTION

Generally in the window and door industry windows are considered to provide the main function of letting in light to a building. Of late it is desirable to have large windows within the building which improve the room lighting but which do not support structural loads. It is therefore primary object of the invention to provide a preferably load bearing structural closure for installation within a building which includes a multiplicity of closures (and preferably casement style) to provide an enhanced straight line assembly. Further and other objects of the invention will become apparent to one skilled in the art with considering following summary of the invention and the more detailed description of the preferred embodiments illustrated herein.

### SUMMARY OF THE INVENTION

According to a primary aspect of the invention there is provided a closure assembly comprising at least two closures moveable in a closure frame, said closure frame including a header, sill and including a track sized to extend the full-length the header and sill thereby providing for guided movement of each individual closure to the maximum extent to and from a fully closed position, the at least two closures presenting a straight line, in-line, closure, such as a window, entry door, French door, patio door assembly and when the closures are pivoted from a closed position whereat said closures are parallel to the extension of said closure frame to a second position wherein free end of the closer is pivoted away from the closure frame, the free end of said closure including an inter-engaging member which inter-engage with adjacent members to brace together said closures thereby against any loading such as wind loads or the like.

This invention takes advantage of prior known inventions also invented by the present inventor including the teachings of U.S. Pat. No. 5,687,506 and specifically FIGS. 1B, 2, and 3 there in. The teachings in relation to the construction of the pivoting shaft, pivot shoes, the rack, pinion and pivot shoe and the inter-engagement thereof are hereby incorporated by reference in their entirety as if they were written into this application. Further the teachings of U.S. Pat. No. 6,405,781 are also hereby incorporated by reference with respect to the teachings of screens contained within a pocket in the jamb of a closure assembly and the pocket being disposed in a jamb section and of a particular shape compatible with the shape of the pivot bracket as best seen in FIG. 48 of that patent.

Specifically referring to the closure assembly construction in the preferred embodiments each consists of a frame including a header sill, and two jamb, each header and sill including racks within each track and sized to fit the full-length of the header and sill in parallel fashion as per the teachings of the herein mentioned patents. The sashes in these frames are built on the same concept. Each casement as illustrated in the figures including a bubble seal all around for exceptional waterproofing and weatherproofing. The shaft is provided on one side at the pivoting end of the closure and includes an engaging pivot shoe that rides in the track which includes a pinion gear riding in the track of the header and still. The opposite side of the closure namely the free end is designed with an inter-engaging extrusion that works as an interlocking portion to secure each closure to one another whether in the closed position or the fully pivoted position. As a result no visible hardware is seen on the outside except for a casement handle on the first sash on the inside. The multiple shafts at the pivoting end also serve to reinforce and strengthen the entire window by co-operating in an interlocking manner with the inter-engaging member at the free end of the closure.

According to yet another aspect of the invention there is provided a closure assembly including multiple closures for example casement French doors patio doors or the like which provide an improved appearance and clean straight line or in line appearance in a parallel closure assembly because of the unique pivoting and interlocking edge.

According to yet another aspect of the invention there is provided a closure assembly having two ends comprising a first and second tracks disposed within the full length of a header and sill portion of said closure assembly proximate the top and bottom of the assembly respectively and extending from end to end of said assembly, at least three slidable and pivotable closure members for movement in relation to said tracks, the closure members including framing sections therefor and being engaged with the tracks proximate first and second pivots adjacent the pivoting end of each closure member, the first and second pivots being interconnected by a multiple segment shaft disposed within framing sections of said closure members, the shaft including at least two portions, the shaft providing for accurate installation, retention, removal, adjustment and alignment of the first and second pivots within the tracks in a substantially parallel line with respect to one another and for pivotally supporting the closure members which may be safely and securely pivoted away from the closure assembly, whereby the first and second interconnected pivots are adapted to remain engaged with the tracks while supporting the closure member both when it is pivoted away from the closure assembly and when it is slidable relative to the tracks, the closure members having a free end and a pivoting end with inter-engaging members proximate the free end of each closure member, which engage the adjacent closure member proximate the free end thereof when said closure members are pivoted to a fully open position and further positioned whereat the pivoting ends of said closure members are also located adjacent one another to provide a maximum opening to exit or enter a building at this position for example when said closure assembly is for a patio door, and wherein when said closures are at a fully closed position when adjacent pivot ends and free ends inter-engage and seal with respect to one another to present a straight line in line flush appearance for all closures in relation to said closure assembly.

According to another aspect of the invention there is provided a closure assembly comprising:
1) an opening extending within a closure frame
ii) the frame having two ends and having disposed therein or attached thereto track portions extending substantially parallel to said frame;
iii) at least three closure member having framing portions and two ends and being slidable within said track portions and pivotable proximate at least one end thereof and latchable in the track portions proximate the free end thereof;
iv) each of said track portions having disposed therein at least one pivot shoe adjacent the pivoting end of each closure member, each shoe being substantially compatibly shaped with the track portions and having a top and bottom, each shoe having disposed therein adjacent the pivoting end of the at least three closure members an opening extending from the top toward the bottom of the shoe wherein pivot means are disposed, said pivot means provided with said pivot shoe being interconnected by a multiple segment shaft disposed within said framing portions of said at least three closure members, the shaft including at least two portions, the shaft providing for accurate installation, retention, removal, adjustment and alignment of the first and second pivots within the track portions in a substantially parallel line for pivotally supporting the at least three closure members for safe and secure pivoting away from the closure assembly;
v) the at three one closure members having latching means provided therewith for latching the at least three closure members in relation to the track portions to prevent the at least three closure members from pivoting upon the pivot means when each closure member remains slidable with said track portions;
vi) the at least three closure members being braced by the multiple segment shaft interconnecting the pivot means disposed with each track portions, the substantially parallel alignment of the pivot means provided by the multiple segment shaft preventing the pivot means from misaligning or disengaging from the relevant track portions when teach closure member is rotated to an open position or when it remains slidable within said track,
(vii) the closure members having a free end and a pivoting end with inter-engaging members proximate the free end of each closure member, which engage the adjacent closure member proximate the free end thereof when said closure members are pivoted to a fully open position and further positioned whereat the pivoting ends of said closure members are also located adjacent one another to provide a maximum opening to exit or enter a building at this position for example when said closure assembly is for a patio door, and wherein when said closures are at a fully closed position when adjacent pivot ends and free ends inter-engage and seal with respect to one another to present a straight line in line flush appearance for all closures in relation to said closure assembly.

Preferably the first and second pivot portions further comprise a rotatable pinion disposed therewith for facilitating the movement of the carrier relative to the track.

Preferably the rotatable pinion moves in cooperation with a rack disposed with said track.

More preferably retractable screens are provided disposed within each jamb of the assembly which accumulates on and pays out from a spring biased roll disposed within each jamb, the screen being retractable for egress or cleaning purposes, and available as desired by providing a detent on the opposite screen handle or closure frame engageable with the screen when in its operatable position.

In a preferred embodiment a pivot shoe is provided for engagement with said rack and track further comprising a carrier having a top and a bottom, the carrier having disposed proximate the bottom thereof means, and preferably slots, for retaining rollers, and the rollers in use thereof for providing the smooth movement of the carrier within the track, preferably the rollers being engaged with a predetermined channel formed in said track, said carrier also having an opening disposed proximate the top thereof wherein a pivot gear is disposed.

### BRIEF DESCRIPTION OF THE DRAWINGS

FIG. 1 is a front view of a patio door assembly wherein multiple closures move in a horizontal direction, and pivot outwardly from said frame illustrated in a preferred embodiment of the invention.

FIG. 2 is front views of casement style multiple patio doors of FIG. 1 embodying the invention and depicting the use of rollout screens and illustrated in a preferred embodiment of the invention.

FIG. 3 is a schematic perspective view of straight line patio doors embodying the invention of FIG. 1 and depicting the inter-engagement members and illustrated in a preferred embodiment of the invention.

FIG. 4 is a similar view of the casement style windows of FIG. 3 depicting closure 35 thereof in an open position and illustrated in a preferred embodiment of the invention.

FIG. 5 is an perspective view of the components of the hardware of FIG. 3 to be installed in a multi closure member assembly.

FIG. 6 is a further perspective view of FIG. 1 with all closures at the pivoted position illustrated in a preferred embodiment of the invention.

FIG. 7 is a further view of the closures of FIG. 6 with the members 34 and 35 both pivoted and moved laterally to a position whereat the free ends of said members inter-engage by inter-engaging members 34M and 35M.

FIGS. 8A and 8B is yet a further schematic and front view of the assembly of FIG. 7 illustrating the closure members at a position allowing for the maximum opening available for exiting the building and illustrated in a preferred embodiment of the invention.

FIG. 8C is a top view of FIG. 8A.

FIG. 9A is a close-up view of the assembly adjacent the top of closure 31 showing the preferred rollout screen assembly

FIG. 9B is illustrating a cassette of prior art.

FIG. 10 is a close-up perspective illustration of the free end of closure member 32 with the inter-engaging member 32M installed at the free end of the closure member and illustrated in one embodiment of the invention.

FIG. 11 is a close-up sectional view of the inter-engagement members shown in FIG. 8 and illustrated in a preferred embodiment of the invention.

FIG. 12 is a similar view to FIG. 11 illustrated in a preferred embodiment of the invention.

FIG. 13 is a close up perspective view of the closure assembly of FIG. 1 illustrating the operation of latching pin P and the engagement of a pivoting end with a free end of adjacent closures.

FIGS. 14 to 16 is prior art.

FIGS. 17A-C and 18A-C Illustrate one of the embodiments of the current invention in different operational states.

### DETAILED DESCRIPTION OF THE INVENTION

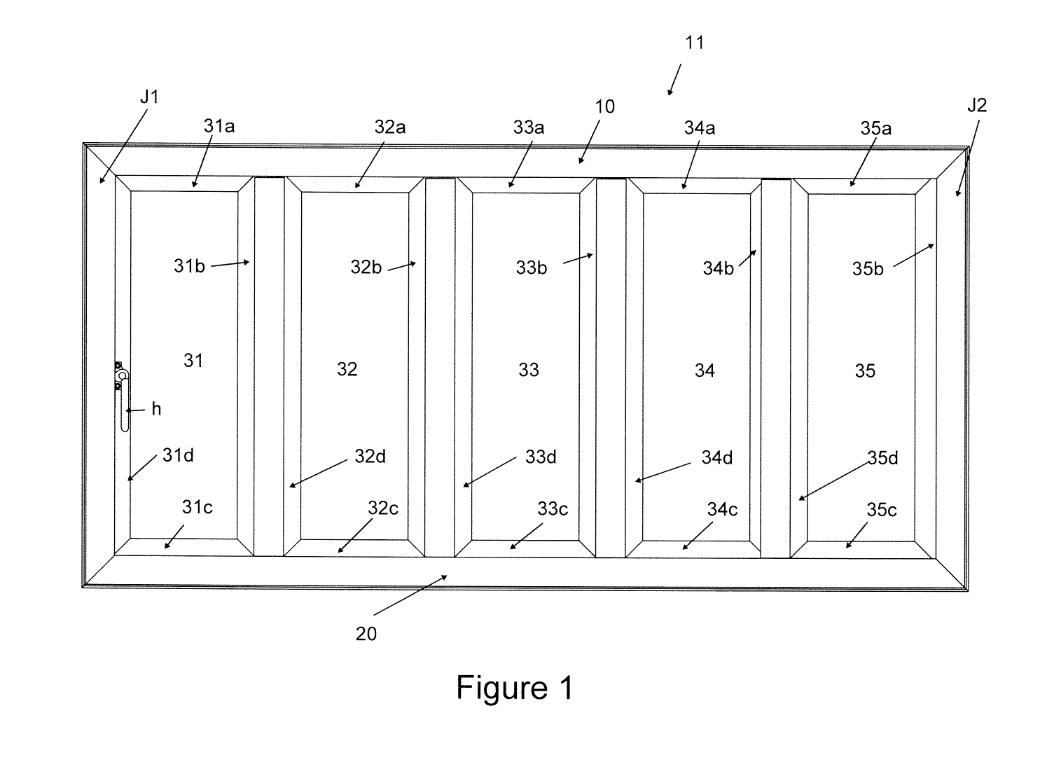

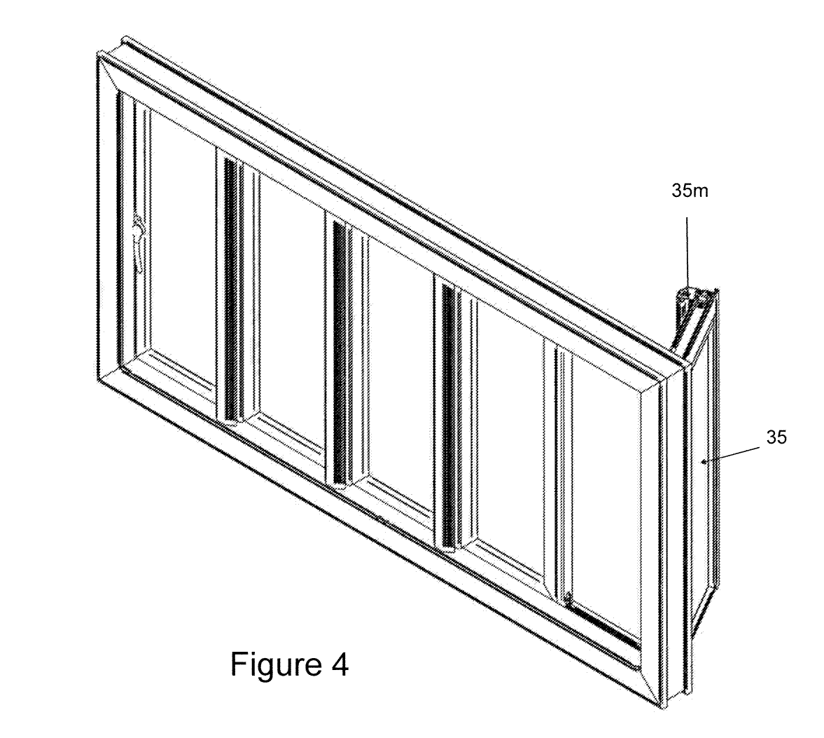

FIG. 1 is a front schematic view of the present invention illustrating five adjacent casement style closures/doors which are interconnected when at the closed position as shown. A special inter-engagement member is disposed adjacent the free end of the closure as best seen in FIG. 4 labeled 35M and provided for each closure with the exception of a closure 31.

A closure framing section 11 therefore is provided including a header and sill 10 and 20 with opposite jambs sections J1 and J2. The header section 10 may be reinforced or alternatively there may be contained within said frame above said header as necessary a lintel or the like load carrying ability of this assembly 11. A pivot shaft is disposed at the pivoting end of each closure/door 31 through 35. Each closure includes framing sections as well.

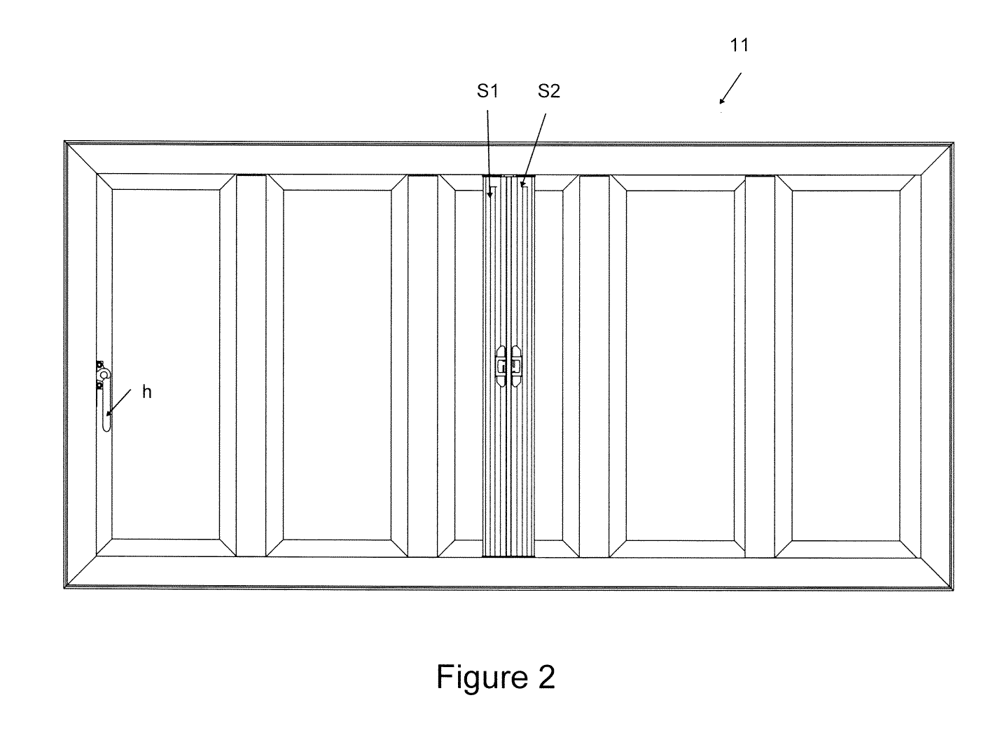

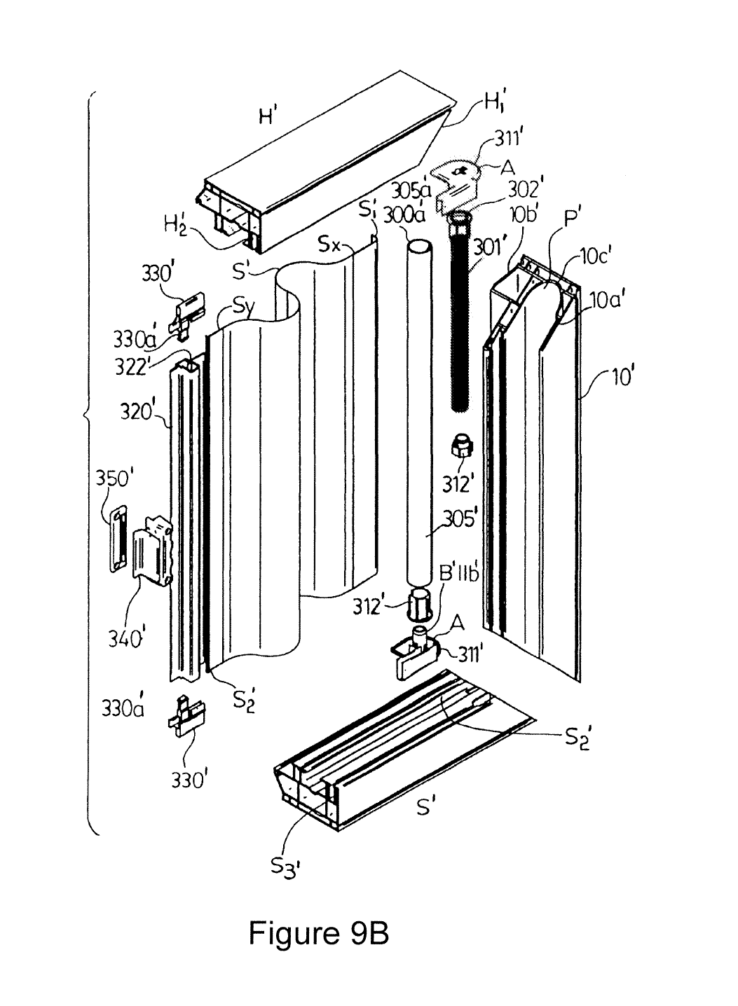

Referring now to FIG. 2 there is shown the invention of FIG. 1 further enhanced by a roll screen system which will be described hereinafter and is best seen in detail in a FIG. 9A. U.S. Pat. No. 6,405,781 also assigned to the present assignee provides the essential teachings of such a roll screen assembly which is incorporated by reference in relation the provision of a pocket in a jamb section of the closure frame and the compatible shape of a pivot bracket with said pocket. As can be clearly a handle H is disposed with the left door member 31.

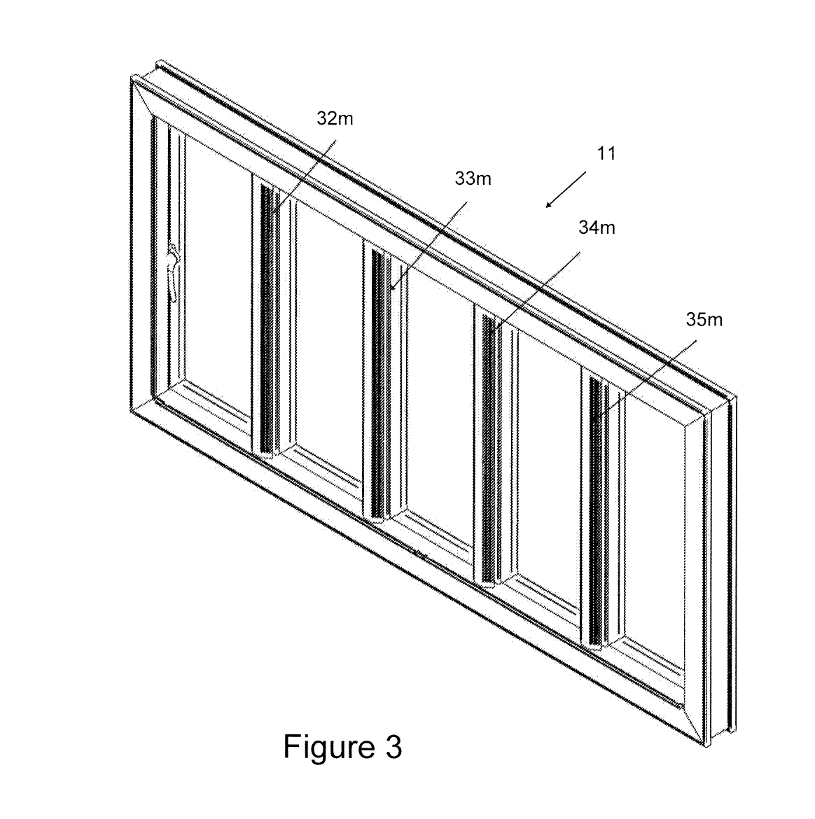

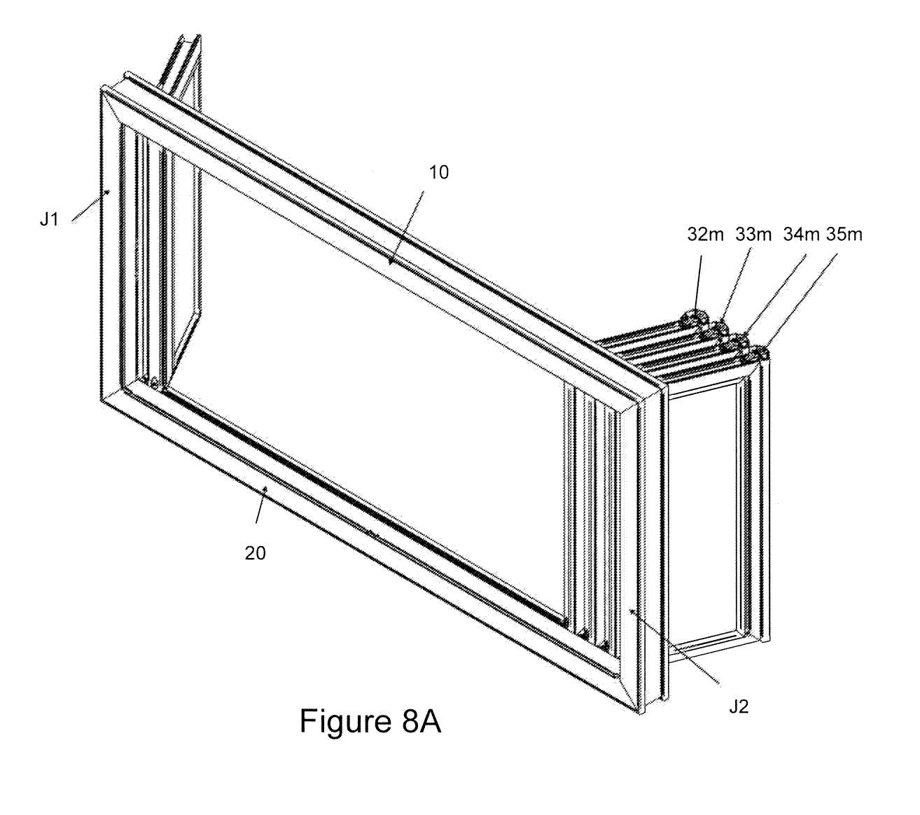

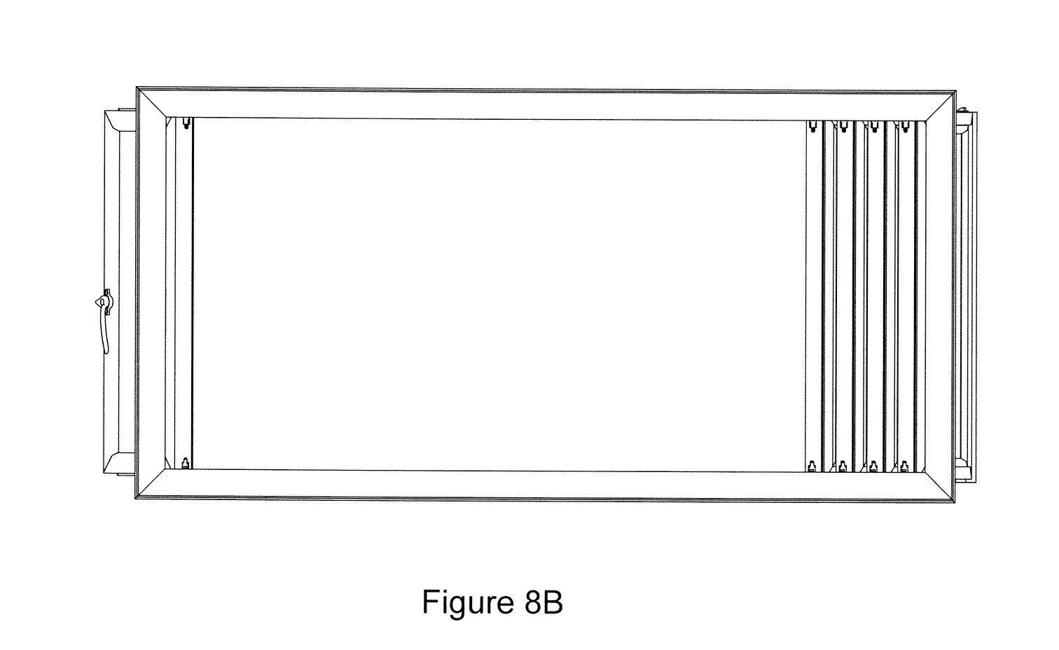

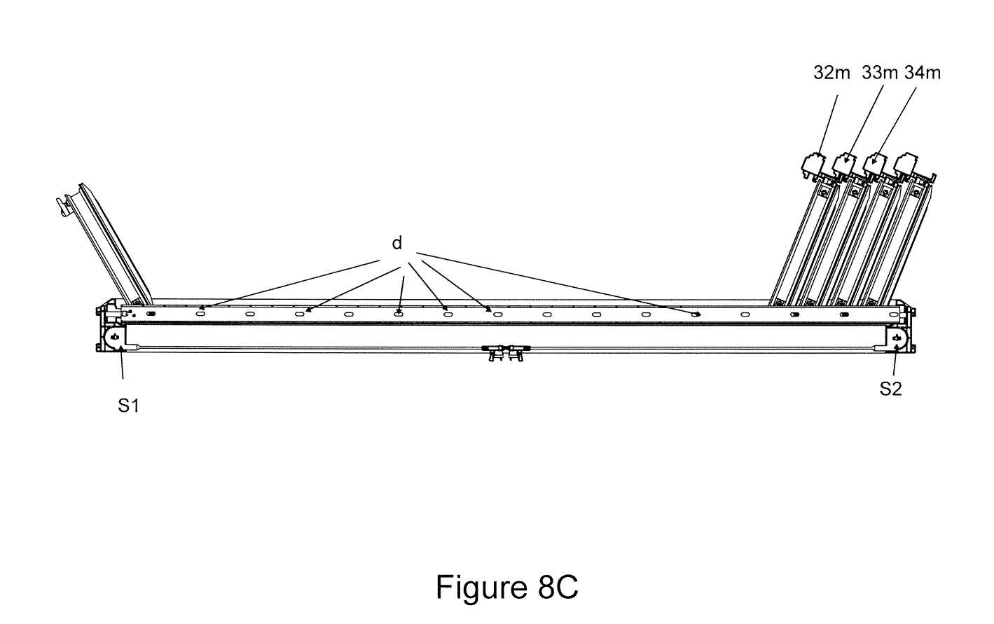

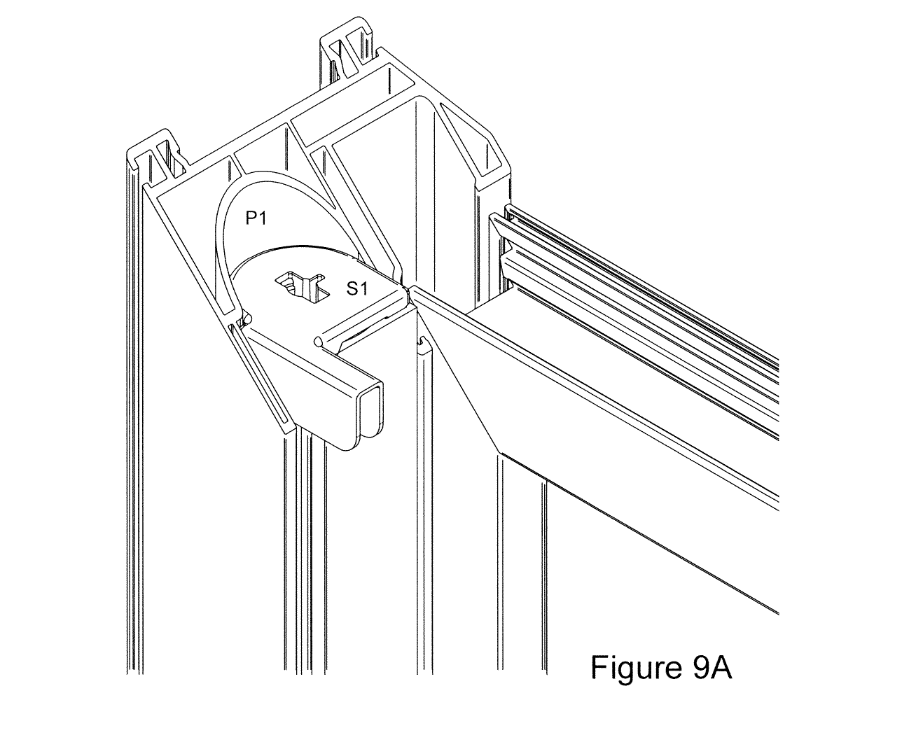

Referring to FIG. 3 the closure assembly is illustrated showing the inter-engaging members 32-35M when at the closed position. These members also inter-engage at the fully pivoted position to brace the assembly against any loading including wind loads. Please refer to FIG. 8 in this regard.

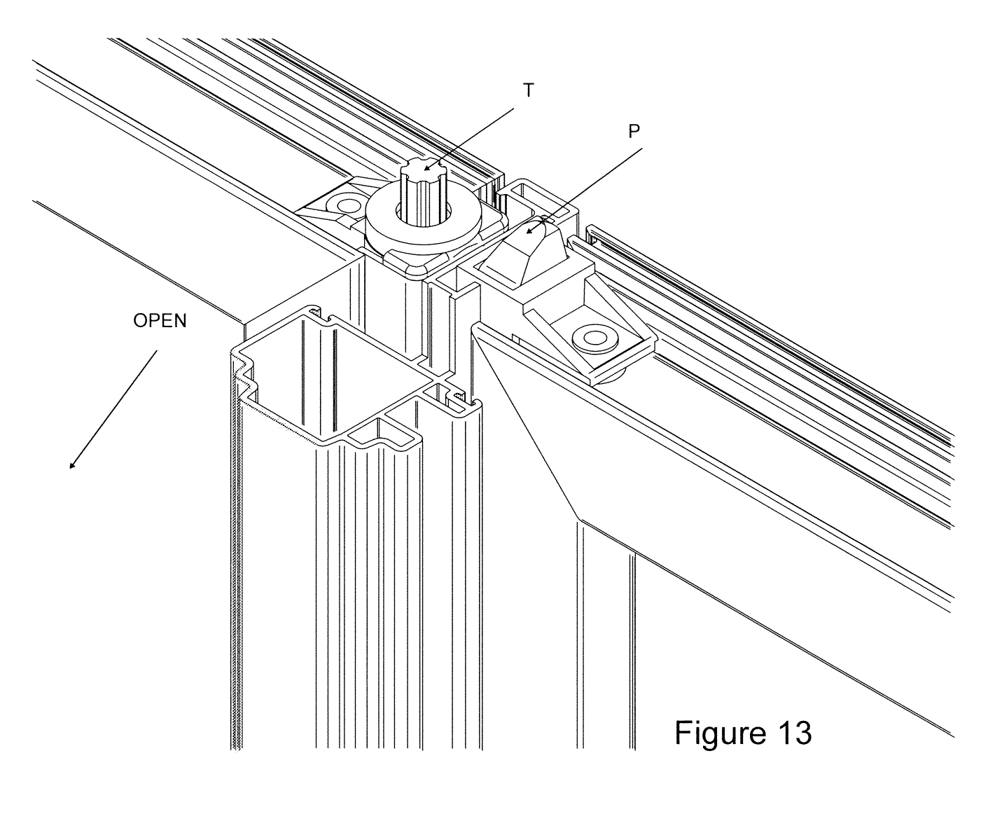

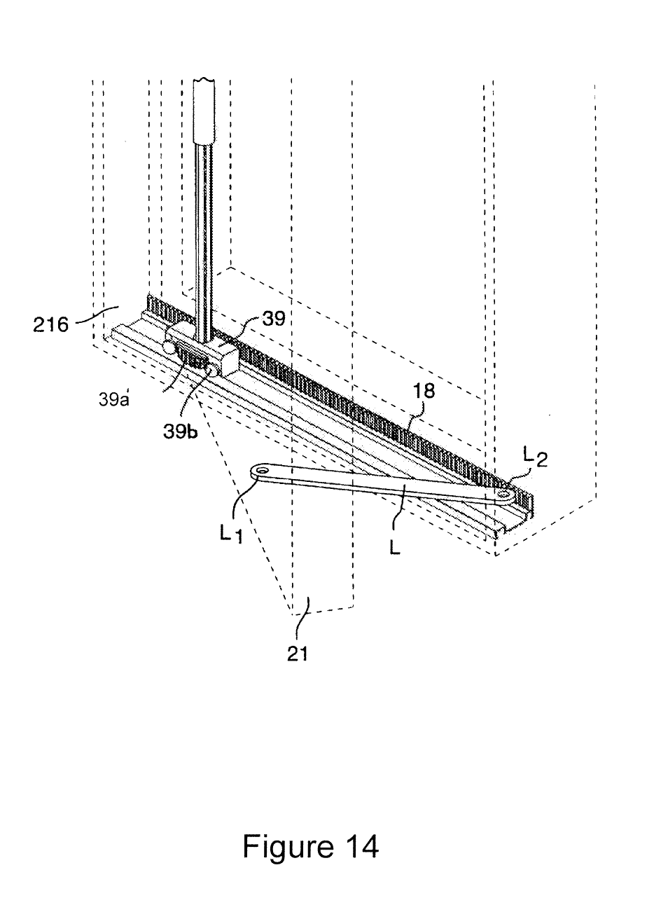

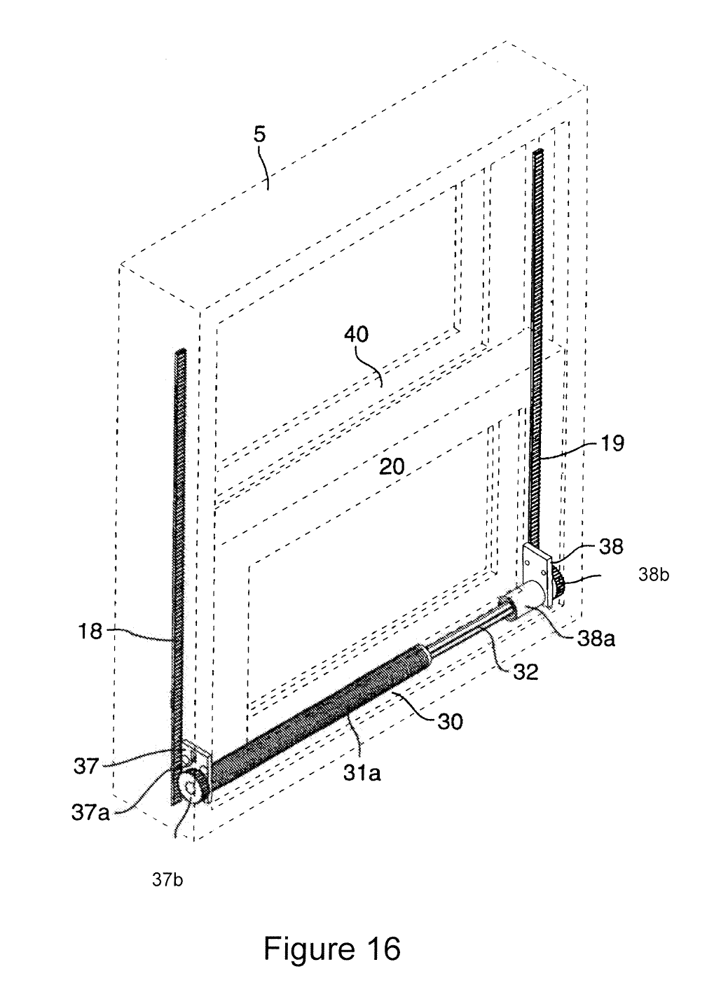

Referring to FIG. 4 and FIG. 13 the closure assembly is shown with the closure member 35 at an open position as seen from the interior of the building. The pivot assembly is constructed according to the teachings of U.S. Pat. No. 5,687,506 as seen in FIGS. 14 through 16 the details of which are incorporated by reference in their entirety in relation to the teachings of the construction of the shaft, the pivot shoe, the rack 18 and cooperating pinion.

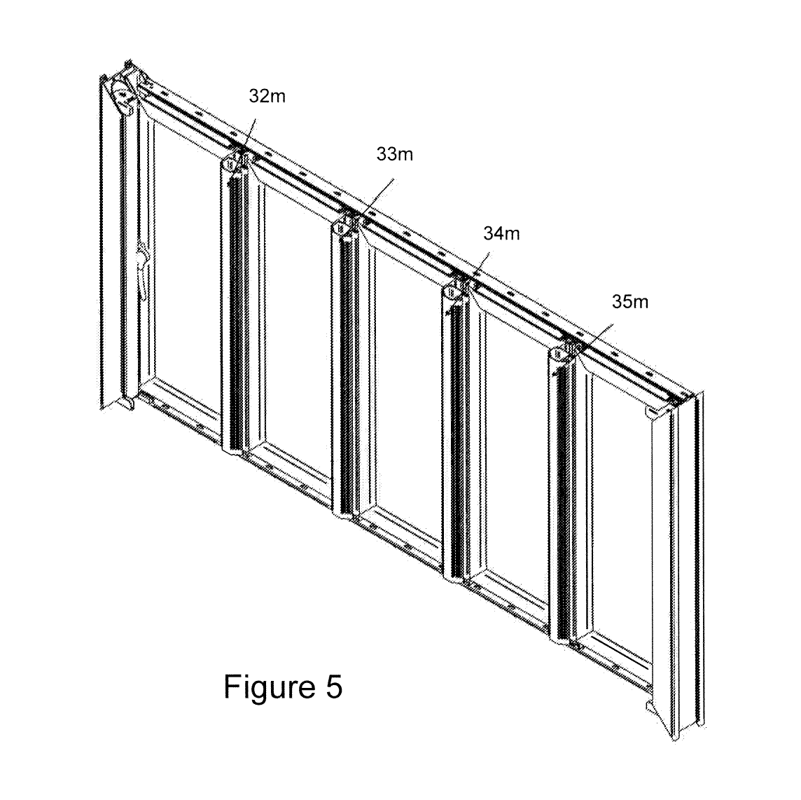

Referring to FIG. 5 there is illustrated the closure assembly with the framing members removed showing bracing members in the header and sill.

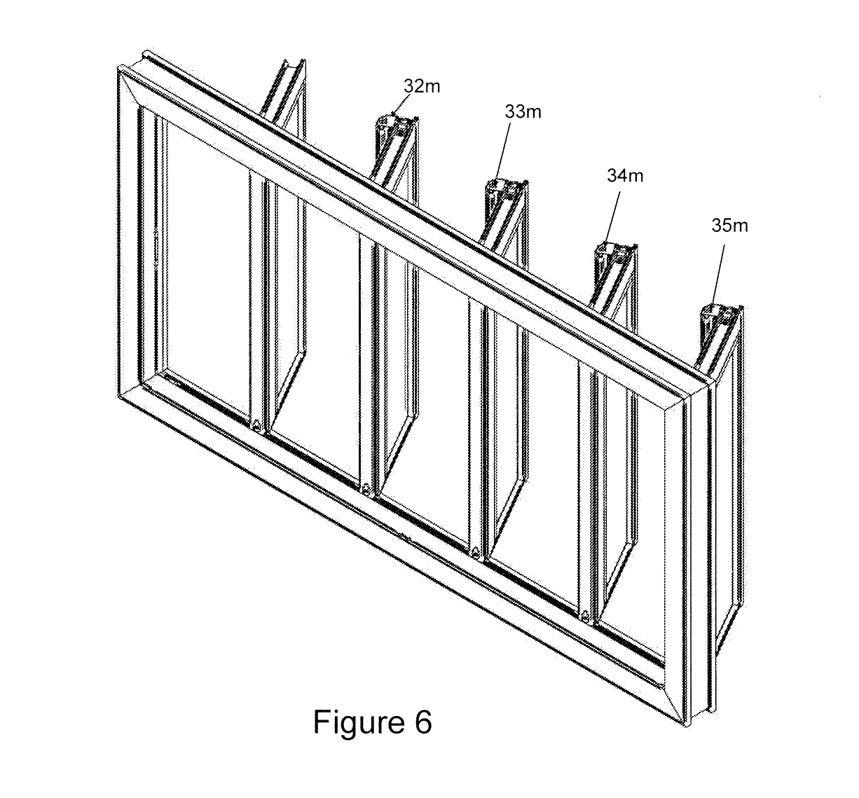

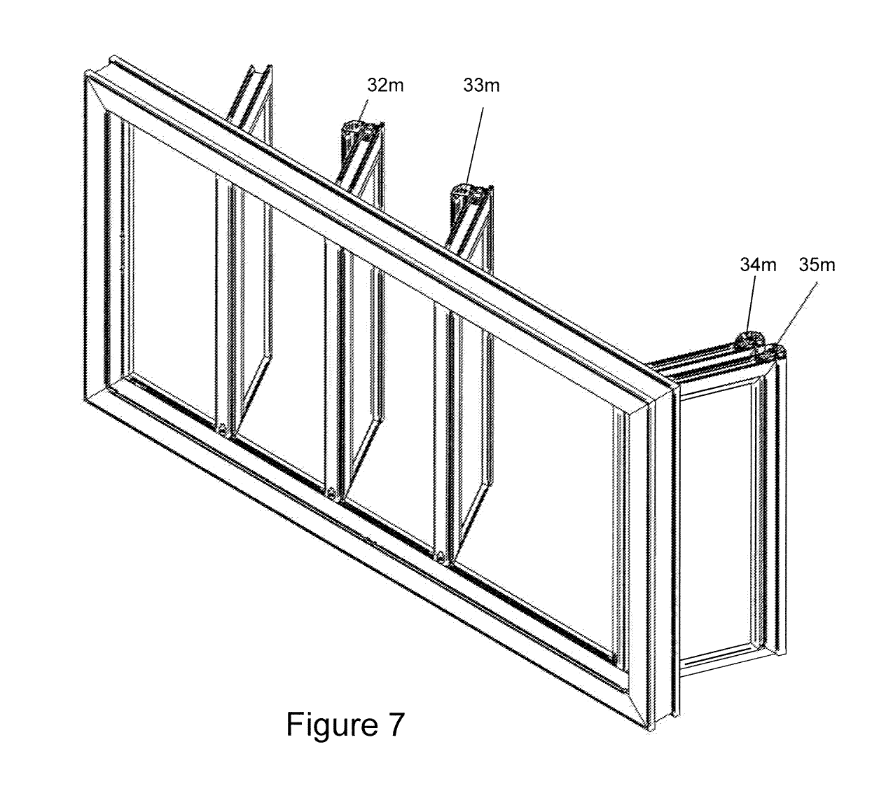

Referring to FIG. 6 there is illustrated the closure assembly with all closures shown in perspective pivoted away from said closure frame on their respective pivots. However each closure has yet to be moved in the track on its pivot shoe. In FIG. 7 closures 34 and 35 are shown with the pivot ends adjacent one another and the free ends thereof braced together by the inter-engagement of members 34M and 35 M as best seen and described in relation to FIG. 11.

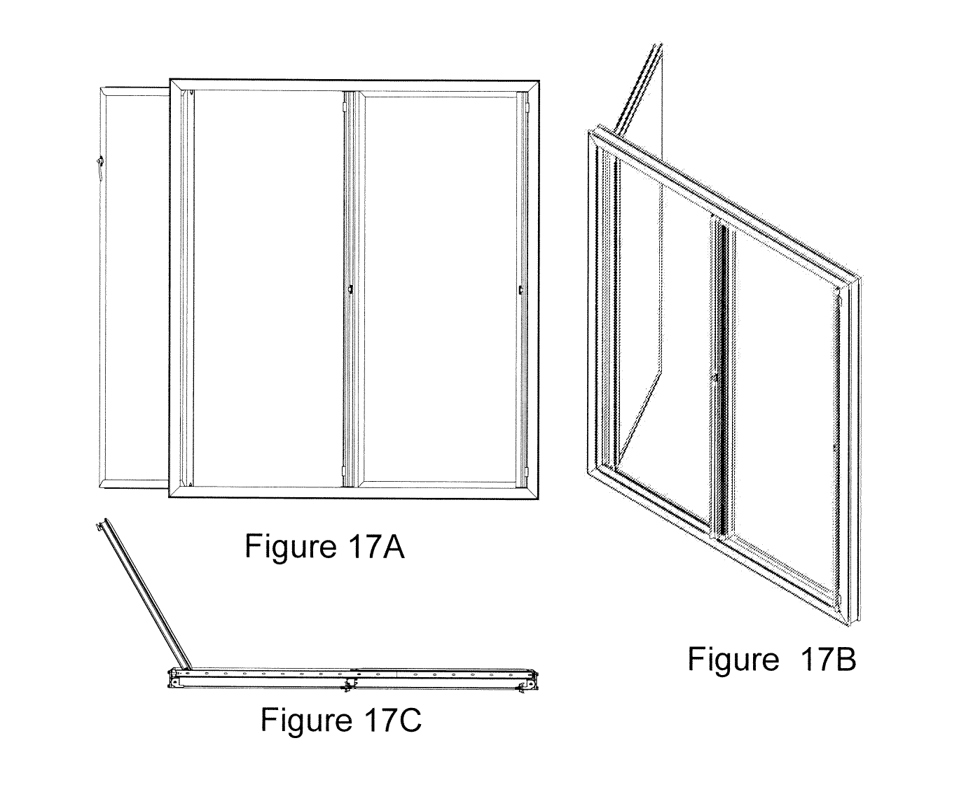

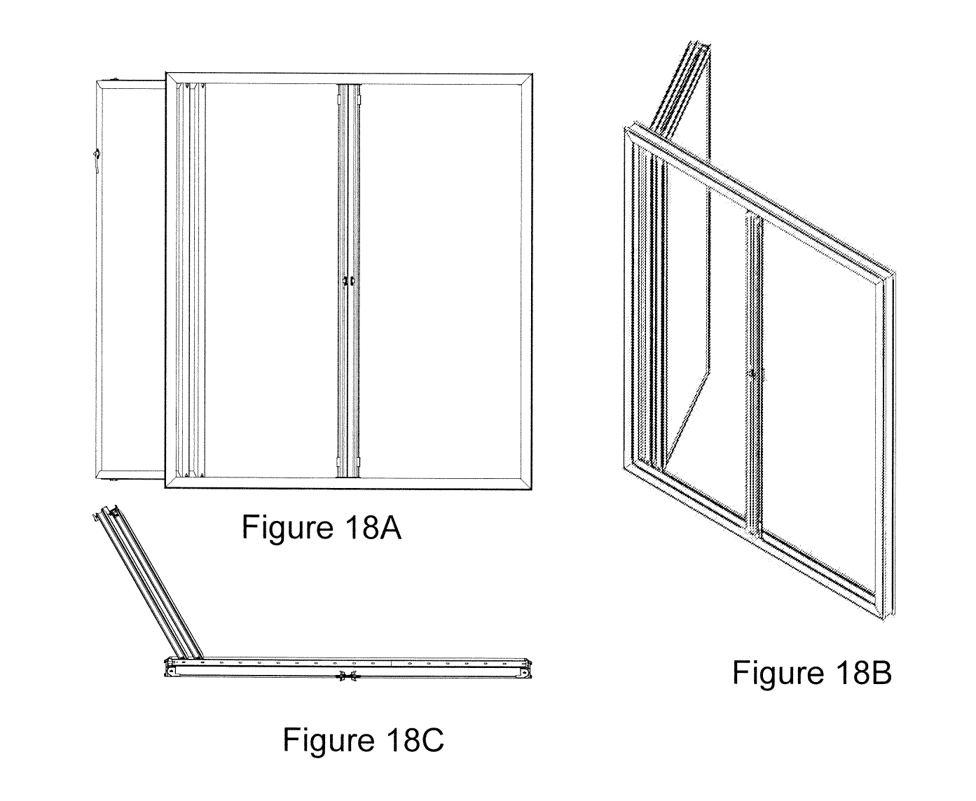

FIGS. 8A and 8B illustrates all closures 31 through 35 at the pivoted position providing the largest opening possible for entry or exit from the interior of the building. The screen assembly may be used to cover that opening when not used to prevent insects from entering. Alternatively sunscreens or shades can be used which can be secured at the various positions shown herein, such as FIG. 5. The free ends of the closures are braced to one another by bracing elements 32M through 35M, the details of which will be described hereinafter. In alternative embodiments other assemblies may include entry doors, French doors, patio doors, casement windows or the like as illustrated in FIGS. 17 and 18. Very large “Window Walls” can be provided which in the example illustrated covers 15 feet openings which is heretofore unknown which opens up many possibilities to interior design.

As best seen in FIG. 8C and FIG. 2 a multiplicity of pinning positions for the pivots (as seen in FIG. 8B) of each closure is illustrated. Further rollout screen assemblies S1 and S2 are shown hidden when not used in the jamb pockets but having handle assemblies butted together and secured as shown. FIG. 9A illustrates the pocket PK from which the screen assembly pays out as taught in the aforementioned patent U.S. Pat. No. 6,405,781 the details of which are illustrated in FIG. 9B. The reader is referred to the description of FIG. 48 in that document the teachings of which are incorporated by reference herein in full.

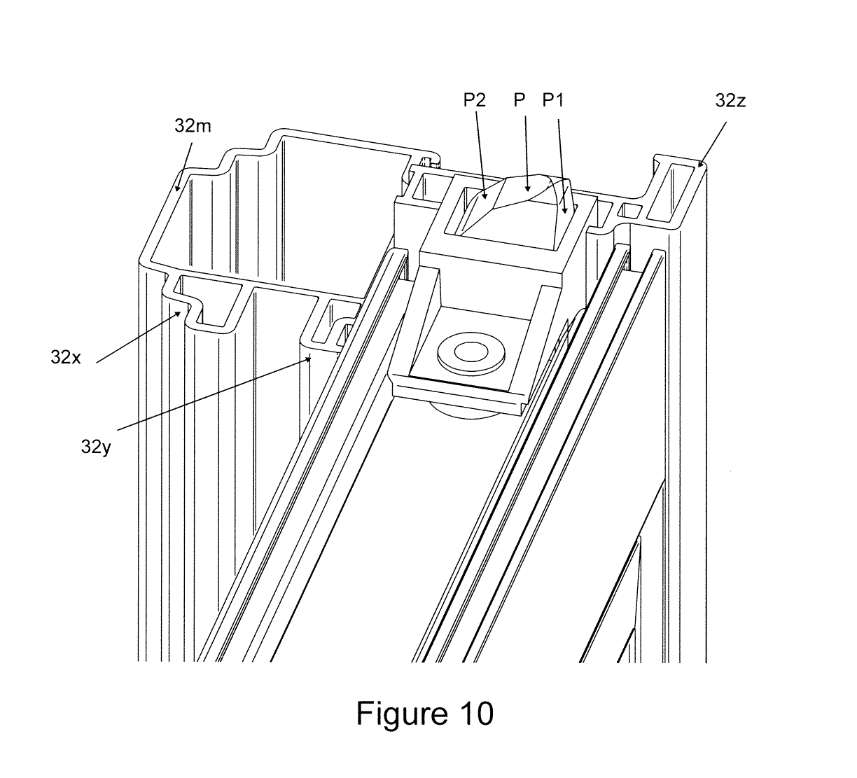

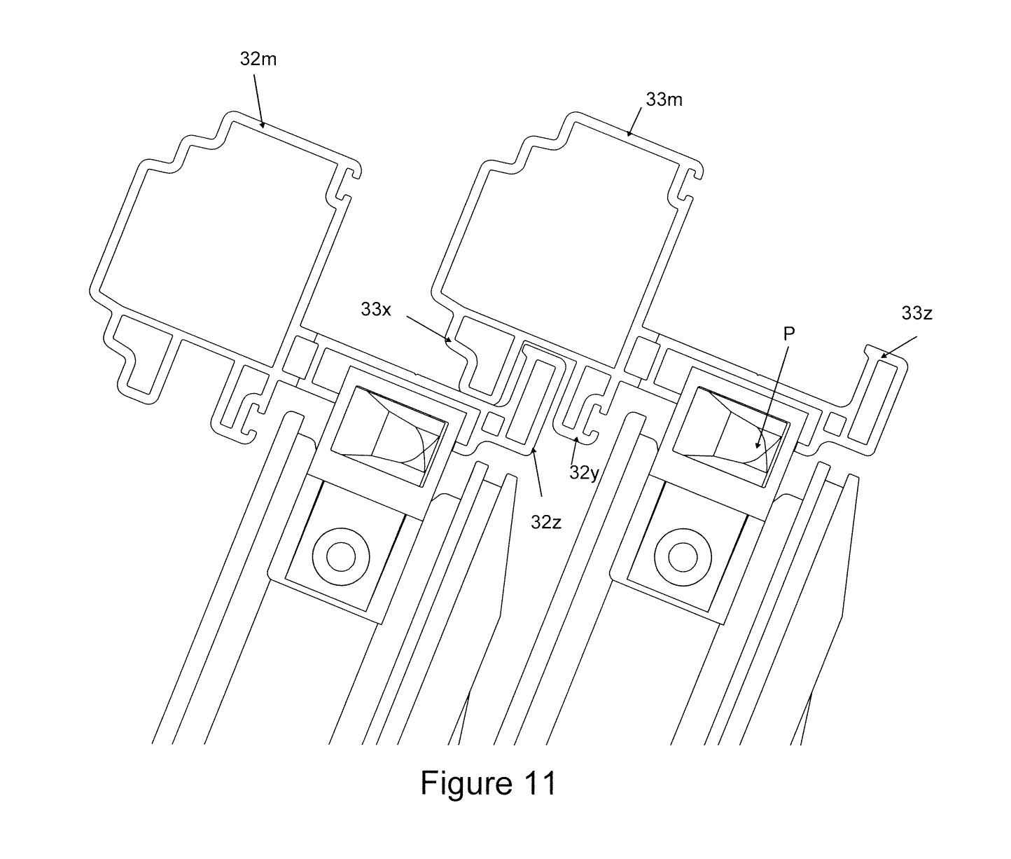

Referring to FIGS. 5, 8C, and 10 the operation of the pin assembly P is illustrated. The pin assembly P is spring biased to a pinned position as seen in FIG. 10 and includes a shoulder P2 which releases from its pinned position when an opening motion of said closure is applied sufficient to overcome the force of the spring. This action permits the closure to move away from the closure frame in the opening direction.

When the closure is moved to the closed position the pin P engages the interior of the closure frame via blunt face P1 and is returned to its pinned position.

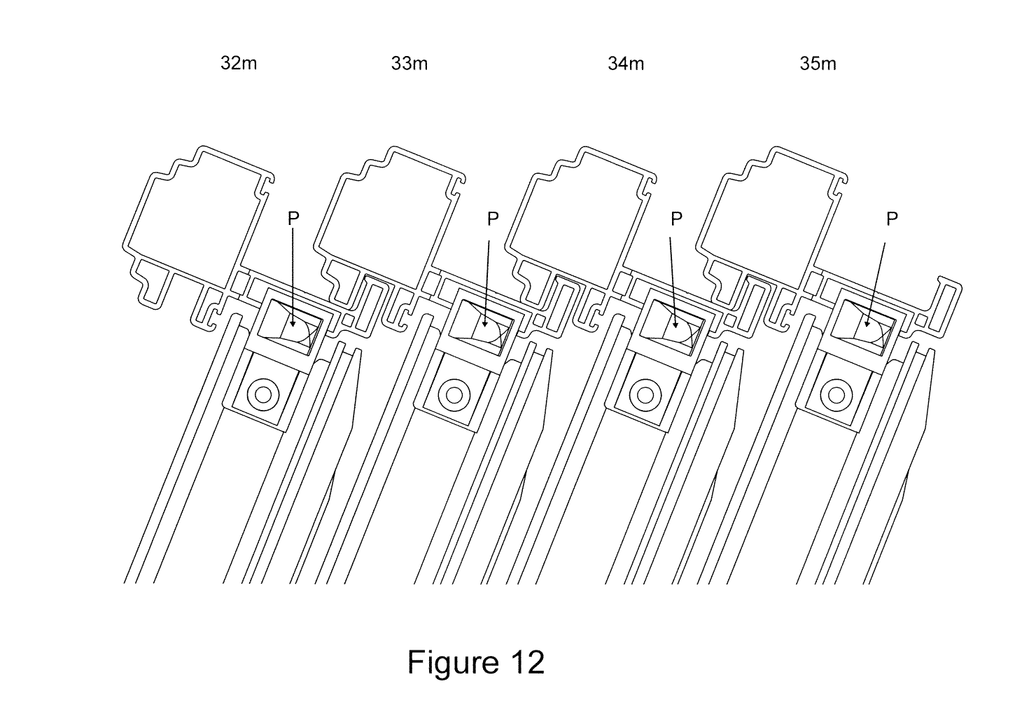

Referring to FIGS. 11 and 12 the details of the inter-engagement of members 32M and 33 M are illustrated. Each member 32M through 35M includes a foot 32Z to 35Z which are capture between tinges 33x and 33y for example to inter-engage said member 32 through 35 at the fully pivoted position as best seen in FIG. 12.

Referring to FIG. 13 there is illustrated the engagement of adjacent closures at the free end and the pivoting end when at the closed position. The closure on the right is free to pivot in an opening direction when sufficient force is applied by pushing on the closure in an opening direction to overcome the spring provided with the pin P. No handle is therefore necessary to do so. This is true for all closures 31 through 35 previously illustrated.

FIGS. 14 to 16 illustrate the pivot assembly of U.S. Pat. No. 5,687,506 used in the present closure assembly the teachings of which are incorporated by reference in the entirety wherein. There is illustrated a casement style window wherein only one sash is provided which is fastened on shaft assembly 30 including portions 31 and 32. A link L is provided secured proximate ends L1 adjacent the center of the sash 21 proximate the bottom thereof and adjacent the track 18 adjacent the opening end of the window sash 21. By positioning the sash in this manner a full range of pivoting motion is available. If the link end L1 is removable from the sash, then the window sash may be moved totally to the opposite end remote the pivoting end 21b on shoe 39. As with the case of the tilt and slide window a shoe 39 containing a pinion is provided. The pinion is connected to the shaft 30 and engages the rack 18 as it moves along the window sill and header in parallel arrangement between the upper and lower pivots maintained in parallel by the shaft 30. In this manner the casement style window may be pivoted as normal to an open position, and the pivoting end may be moved to the other end of the window frame away from side 21b to allow ease of cleaning. By supplying the hardware described without a casement sash, the casement window may be assembled without the need for expensive pivots and linkages and without a great deal of assembly labour. For the casement style window in particular a rollaway screen S may be provided which is housed in the jamb channel as illustrated. The screen S pulls across to engage detent D1 with detent D2 in the opposite channel jamb, whereat it may be locked. This allows a user to clean the glass of sash 21 on the inside without the need to remove the screen as in prior art casement structures.

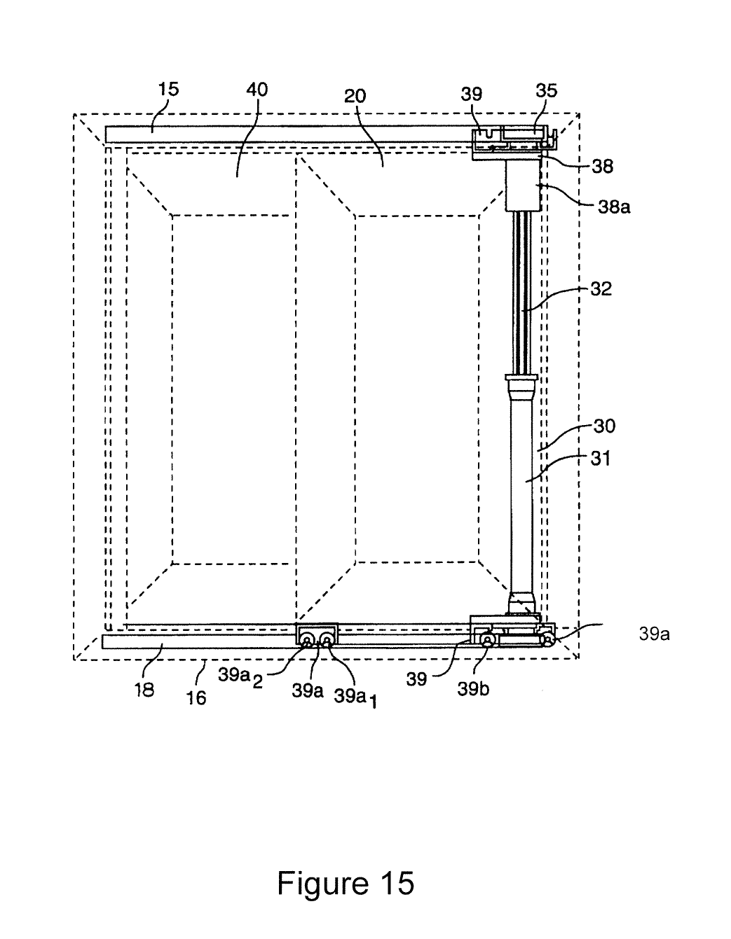

In FIG. 15 windows 20 and 40 are slidable within a track 15 and 17 upon a shoe 39. The lower shoe 39 may also be connected to a secondary shoe 39a as desired for carrying the window which includes rollers 39b and 39a1 on the bottoms thereof respectively for ease of movement within track 17. The pinion 35 rests within the shoe 39 as will be described hereinafter. The arrangement of the interconnecting portion 30 will also be described hereinafter. Window 40 therefore has its own interconnected system.

FIG. 17A illustrates a two pain closure with the left closure open and right closure shut as best seen in FIGS. 17B and 17C. In this illustration the two bug screens are in a closed position abutting proximate the center of the opening. FIGS. 18A-C illustrates the same embodiment of the closure with two pains while the right pane is moved to the left of the closure as best illustrated in FIG. 18B. The bug screens in this embodiment are also closed.

As many changes can be made to the preferred embodiments of the invention without departing from the scope thereof. It is intended that all matter contained herein be considered illustrative of the invention and not it a limiting sense.

1. A closure assembly having two ends comprising a first and second track disposed within the full length of a header and sill portion of said closure assembly proximate the top and bottom of the assembly respectively and extending from end to end of said assembly, at least three slidable and pivotable closure members for movement in relation to said tracks, the closure members including framing sections therefor and being engaged with the tracks proximate first and second pivots adjacent the pivoting end of each closure member, the first and second pivots being interconnected by a multiple segment shaft disposed within framing sections of said closure members, the shaft including at least two portions, the shaft providing for accurate installation, retention, removal, adjustment and alignment of the first and second pivots within the tracks in a substantially parallel line with respect to one another and for pivotally supporting the closure members which may be safely and securely pivoted away from the closure assembly, whereby the first and second interconnected pivots are adapted to remain engaged with the tracks while supporting the closure member both when it is pivoted away from the closure assembly and when it is slidable relative to the tracks, the closure members having a free end and a pivoting end with inter-engaging members proximate the free end of each closure member, which engage the adjacent closure member proximate the free end thereof when said closure members are pivoted to a fully open position and further positioned whereat the pivoting ends of said closure members are also located adjacent one another to provide a maximum opening to exit or enter a building at this position for example when said closure assembly is for a patio door, and wherein when said closures are at a fully closed position when adjacent pivot ends and free ends inter-engage and seal with respect to one another to present a straight line in line flush appearance for all closures in relation to said closure assembly.

2. A closure assembly comprising:
i) an opening extending within a closure frame;
ii) the frame having two ends and having disposed therein or attached thereto track portions extending substantially parallel to said frame;
iii) at least three closure members having framing portions and two ends and being slidable within said track portions and pivotable proximate at least one end thereof and latchable in the track portions proximate the free end thereof;
iv) each of said track portions having disposed therein at least one pivot shoe adjacent the pivoting end of each closure member, each shoe being substantially compatibly shaped with the track portions and having a top and bottom, each shoe having disposed therein adjacent the pivoting end of the at least three closure members an opening extending from the top toward the bottom of the shoe wherein pivot means are disposed, said pivot means provided with said pivot shoe being interconnected by a multiple segment shaft disposed within said framing portions of said at least three closure members, the shaft including at least two portions, the shaft providing for accurate installation, retention, removal, adjustment and alignment of the first and second pivots within the track portions in a substantially parallel line for pivotally supporting the at least three closure members for safe and secure pivoting away from the closure assembly;
v) the at least three one closure members having latching means provided therewith for latching the at least three closure members in relation to the track portions to prevent the at least three closure members from pivoting upon the pivot means when each closure member remains slidable with said track portions;
vi) the at least three closure members being braced by the multiple segment shaft interconnecting the pivot means disposed with each track portions, the substantially parallel alignment of the pivot means provided by the multiple segment shaft preventing the pivot means from misaligning or disengaging from the relevant track portions when each closure member is rotated to an open position or when it remains slidable within said track;
(vii) the closure members having a free end and a pivoting end with inter-engaging members proximate the free end of each closure member, which engage the adjacent closure member proximate the free end thereof when said closure members are pivoted to a fully open position and further positioned whereat the pivoting ends of said closure members are also located adjacent one another to provide a maximum opening to exit or enter a building at this position for example when said closure assembly is for a patio door, and wherein when said closures are at a fully closed position when adjacent pivot ends and free ends inter-engage and seal with respect to one another to present a straight line in line flush appearance for all closures in relation to said closure assembly.

3. The assembly of claim 1, wherein the first and second pivot portions further comprise a rotatable pinion disposed therewith for facilitating the movement of the carrier relative to the track.

4. The assembly of claim 2, wherein the first and second pivot portions further comprise a rotatable pinion disposed therewith for facilitating the movement of the carrier relative to the track.

5. The assembly of claim 3 wherein the rotatable pinion moves in cooperation with a rack disposed with said track.

6. The assembly of claim 4 wherein the rotatable pinion moves in cooperation with a rack disposed with said track.

7. The assembly of claim 5 wherein a pivot shoe is provided for engagement with said rack and track further comprising a carrier having a top and a bottom, the carrier having disposed proximate the bottom thereof means, and preferably slots, for retaining rollers, and the rollers in use thereof for providing the smooth movement of the carrier within the track, preferably the rollers being engaged with a predetermined channel formed in said track, said carrier also having an opening disposed proximate the top thereof wherein a pivot gear is disposed.

8. The assembly of claim 6 wherein a pivot shoe is provided for engagement with said rack and track further comprising a carrier having a top and a bottom, the carrier having disposed proximate the bottom thereof means, and preferably slots, for retaining rollers, and the rollers in use thereof for providing the smooth movement of the carrier within the track, preferably the rollers being engaged with a predetermined channel formed in said track, said carrier also having an opening disposed proximate the top thereof wherein a pivot gear is disposed.

9. The assembly of any one of claims 1 to 8 wherein retractable screens are provided disposed within each jamb of the assembly which accumulates on and pays out from a spring biased roll disposed within each jamb, the screen being retractable for egress or cleaning purposes, and available as desired by providing a detent on the opposite screen handle or closure frame engageable with the screen when in its operable position.
